(19) United States
(12) Patent Application Publication
(10) Pub. No.: US 2018/0181289 A1
(43) Pub. Date: Jun. 28, 2018

(54) SIZING APPLICATIONS BASED ON DISPLAY PARAMETERS

(71) Applicant: Lenovo (Singapore) Pte. Ltd., Singapore (SG)

(72) Inventors: Arnold S. Weksler, Raleigh, NC (US); John Carl Mese, Cary, NC (US); Russell Speight VanBlon, Raleigh, NC (US); Nathan J. Peterson, Oxford, NC (US)

(21) Appl. No.: 15/391,798

(22) Filed: Dec. 27, 2016

(51) Int. Cl. G06F 3/0484; G06F 3/14; G09G 5/391; G09G 5/38

(52) U.S. Cl. CPC G06F 3/04847; G09G 5/38; G09G 5/391; G06F 3/1454

(57) ABSTRACT

One embodiment provides a method, including: receiving, at an information handling device, an indication to display at least one application on a display screen connected to the information handling device; accessing, using a processor, a rule set comprising rules for adjusting a window size for the at least one application based upon a display parameter of the display screen and a user-defined window size setting; and adjusting, based upon the rule set, the window size of the at least one application. Other aspects are described and claimed.

### BACKGROUND

Information handling devices (“devices”), for example smart phones, smart TVs, tablet devices, laptop computers, and the like, permit users to view applications (e.g., media players, web browsers, word processors, etc.) on display screens associated with the devices. Additional display screens (e.g., monitors, other devices with displays, etc.) can be connected to the devices. Advances in technology have enabled users to transfer applications between the connected display screens.

### BRIEF SUMMARY

In summary, one aspect provides a method, comprising: receiving, at an information handling device, an indication to display at least one application on a display screen connected to the information handling device; accessing, using a processor, a rule set comprising rules for adjusting a window size for the at least one application based upon a display parameter of the display screen and a user-defined window size setting; and adjusting, based upon the rule set, the window size of the at least one application.

Another aspect provides an information handling device, comprising: a processor; a memory device that stores instructions executable by the processor to: receive an indication to display at least one application on a display screen connected to the information handling device; access a rule set comprising rules for adjusting a window size for the at least one application based upon on a display parameter of the display screen and a user-defined window size setting; and adjust, based on the rule set, the window size of the at least one application.

A further aspect provides a product, comprising: a storage device that stores code, the code being executable by a processor and comprising: code that receives an indication to display at least one application on a display screen connected to an information handling device; code that accesses a rule set comprising rules for adjusting a window size for the at least one application based upon a display parameter of the display screen and a user-defined window size setting; and code that adjusts, based on the rule set, the window size of the at least one application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting a window size of an application.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The ability to transfer applications between display screens has provided users with greater versatility to interact with application content. Due to this flexibility, users are no longer limited to viewing an application on a singular display screen. Rather, users may initiate an application on a first display screen and then continue interacting with that application on another display screen, for example, another display screen connected to the device, a display screen connected through a network connected to the device, a display screen connected through a near field communication channel, and the like. For example, a user may initiate a spreadsheet application (e.g., Excel® for Windows®) on a laptop computer and display the spreadsheet on the laptop's original display screen. A user may then connect an additional display screen (e.g., a monitor, laptop computer with monitor, tablet, etc.) to the laptop and then transfer (e.g., by dragging, swiping, moving, etc.) the application to the additional display.

When transferring an application between display screens, the application may automatically open on the target display screen in a predetermined display mode (e.g., full screen, half-screen, quad-screen, full-text, restore down, etc.). The predetermined display mode is typically associated with the how the application was displayed on the first display. The resulting window size of the application on the target display screen may not align with a user's viewing preference for that application because the original display screen may have different display parameters (e.g., display size, display resolution, etc.) than the target display screen. For example, when transferring an application from a laptop monitor having a 13.3″ screen size with a 1024×768 display resolution to a much larger connected monitor having a 30″ screen size with a 4,000×2,000 display resolution (i.e., 4K resolution), the window size of the application may increase dramatically. Depending on the application, the larger window size may not be preferential to the user.

Conventionally, in order to view a transferred application at a desired viewing size, a user must manually adjust the window size of the transferred application. For example, while a user may want to display an electronic document on a reading application in full screen mode on a smaller screen, when transferred to a larger screen, the user may only need half of the screen to properly visualize the application. In such a situation, a user must manually adjust the window size (e.g., by dragging the edges of the window, selecting a window resize button, leveraging a combination of keyboard keys, etc.) of the application to their preferred viewing setting. In another example, when an application is transferred from a small screen to a large screen, the application window size may be so large that the application window edges extend beyond the borders of the target display screen. In these situations, many resize options (e.g., window edge dragging, window minimize buttons, etc.) may be unavailable and users must employ alternative adjustment techniques, which may not be intuitive or readily apparent to many users. Therefore, these conventional techniques are both time consuming and cumbersome.

Accordingly, an embodiment provides a method of dynamically adjusting a window size of an application based upon display parameters and/or user-defined window size settings. In an embodiment, responsive to receiving an indication (e.g., an initiation event, a repositioning event, etc.) to display an application on a display screen, an embodiment may access a rule set. The rules set may include rules for adjusting a window size of the application depending on a display parameter of the display screen and/or a user-defined window size setting. An embodiment may then adjust the window size of the application based upon the rule set. Such a method eliminates the need for users to manually adjust the window size of transferred applications to their desired viewing mode each time an application is transferred to another display screen.

The illustrated example embodiments will be best understood by reference to the figures. The following description is intended only by way of example, and simply illustrates certain example embodiments.

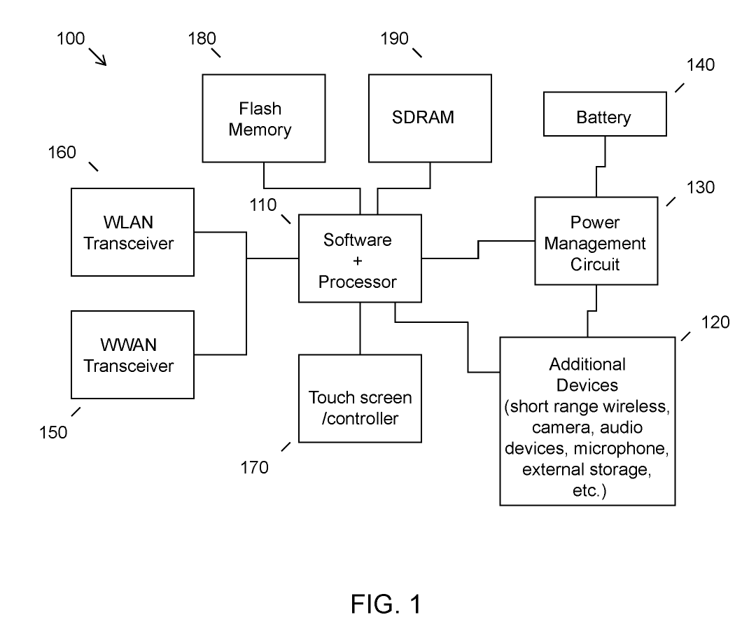

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

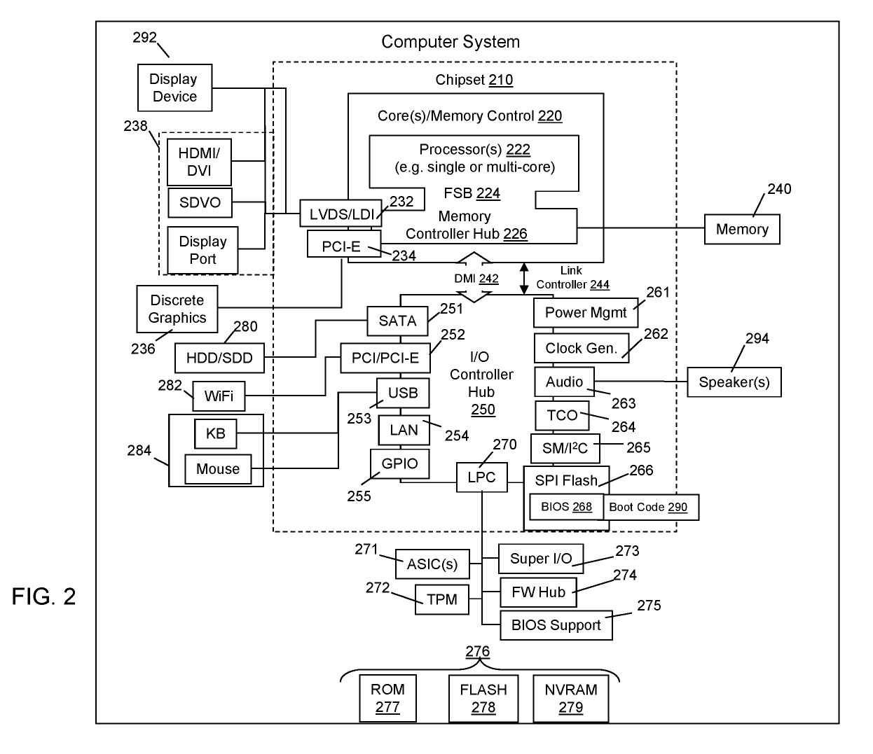

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may automatically adjust a window size of an application transferred between display screens to a preferred viewing size. For example, the circuitry outlined in FIG. 1 may be implemented in a tablet or smart phone embodiment, whereas the circuitry outlined in FIG. 2 may be implemented in a personal computer embodiment.

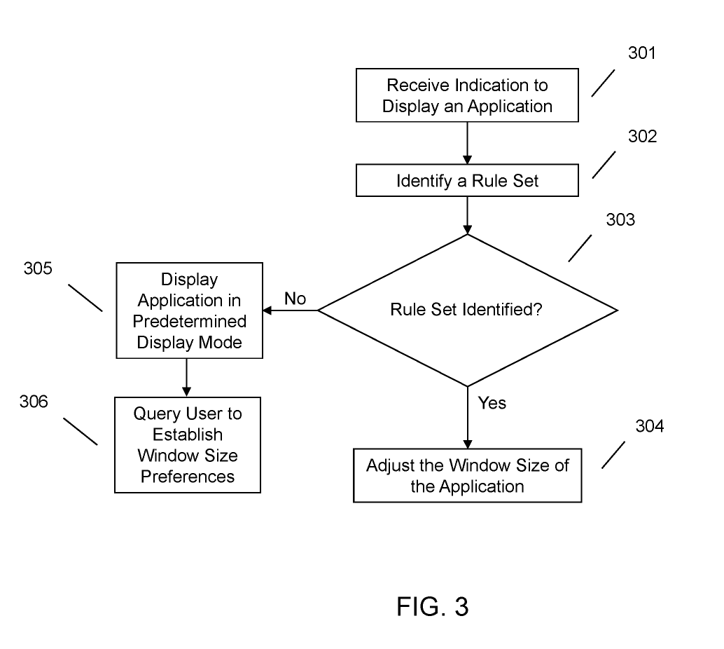

Referring now to FIG. 3, an embodiment may adjust a window size of an application on a display screen based on an accessed rule set. At 301, an embodiment may receive an indication to display at least one application on a display screen connected to a device. In an embodiment, the indication may be an application initiation event, a repositioning event, and the like. An application initiation event may be an event which opens a new application. For example, an application initiation event may include a user-initiated launching of an application (e.g., by clicking on an application icon on a single display screen, selecting an application from a list, or otherwise initiating an application, etc.), a system launch of an application, and the like. A repositioning event may be an event where an already open application is moved from one location to another. For example, a repositioning event may include transferring of the application between display screens, dragging an application between screens, moving an application on a display screen, and the like. For example, a repositioning event may occur when a user transfers a media playing application (e.g., Netflix®, video player, music player, etc.) from one display screen to another display screen.

In an embodiment, a device may be operatively connected or coupled to multiple display screens either physically (e.g., using wires, connectors, etc.), via a wireless connection (e.g., using a BLUETOOTH connection, near field communication (NFC), wireless connection techniques, etc.), or the like. The transferring action in a repositioning event may be any action for transferring an application between display screens such as dragging the application between the display screens (e.g., using a mouse to click and drag the application, using an input device to select an application to move, etc.), sending the application between the display screens utilizing BLUETOOTH, NFC, or other wireless transmission techniques, and the like.

At 302, an embodiment may access a rule set for adjusting a window size of a specific application, application type (e.g., media playing application, image editing application, word processing application, etc.), applications for a particular user, and the like. In an embodiment, the rule set may be stored locally on the device or may be stored at an accessible remote storage location (e.g., the cloud, another device, network storage, etc.). The rule set may include rules for adjusting a window size based upon a display parameter of the display screen and/or a user-defined window size setting. In an embodiment, different display screens may have different display parameters (e.g., physical display screen size, virtual display screen size, number of applications currently open, display screen resolution, display screen capacity, etc.). In an embodiment, the display parameters of the display screen may be communicated to the device or, alternatively, identified by the device through the connection link.

In an embodiment, the user-defined window size setting may define a window size for a particular application, application type, particular user, and the like. In an embodiment, the user-defined window size setting may be selected from a group of window size settings including a recently used window size, a frequent window size, a crowdsourced window size, a user-defined window size, and the like. The size of the application window may vary depending upon the window size setting utilized. Additionally, the application window size may be different for different applications, different application types, different users using the same device, different environmental conditions (e.g., applications are larger based upon low light, etc.), different device types (e.g., applications are smaller for hand-held devices due to an estimated distance of the user from the display, etc.), and the like.

In an embodiment, a recently used window size setting may correspond to the last window size selected for a particular application or application type by a user (e.g., an identified specific user, any user of a particular device, any user of a device having a particular display size, etc.). For identifying a recently used window size setting, an embodiment may identify (e.g., by accessing an event log, by accessing historically stored data, etc.) the last instance that the application screen size was adjusted by the user. For example, an embodiment may identify that a user last adjusted a particular media playing application to full screen mode. In another example, an embodiment may identify that a user last adjusted a web browsing application (e.g., Chrome® for Google®, Safari® for Apple®, etc.) to half screen mode and correspondingly designate the most recent window size for all web-browsing applications to be half screen mode. Alternatively, an embodiment may designate the most recent window size for different types of similar applications differently, for example, Chrome® has a recent window size designation and Safari® had a different recent window size designation.

In an embodiment, a frequently used window size setting may correspond to the most common window size selected for a particular application or application type by a user. In determining a frequently used window size setting, an embodiment may identify, using similar methods or techniques as identified above, the most common window size for a particular application or application type used by a user by analyzing prior window size adjustments by the user. For example, an embodiment may identify that a user frequently adjusts the size of a particular word processing application to half screen mode or to particular locations on the display screen. In another example, an embodiment may identify that a user frequently adjusts the size of all media playing applications to full screen mode, but adjusts the size of all word processing applications to half screen mode.

In an embodiment, a crowdsourced window size setting may correspond to the most common window size selected for a particular application or application type by a plurality of users. In determining a crowdsourced window size setting, an embodiment may access a database containing stored input data from a plurality of users. The stored input may correspond to the most common window size selected by the plurality of users for a particular application or application type. For example, an embodiment may identify (e.g., by accessing a database of stored user inputs) that the most common window size selected by a majority of users for a particular media playing application (e.g., Netflix®) is full screen mode, whereas the most common window size selected for another media playing application (e.g., YouTube®) is half screen mode. In another example, an embodiment may identify (e.g., by accessing a database of stored user inputs) that the most common window size selected by a majority of users for all word processing applications is full screen mode. In an embodiment, the database can be accessed locally (e.g., on the device, etc.) or may be accessed remotely (e.g., the cloud, network storage, storage on another device, etc.).

Responsive to identifying the rule set, at 303, an embodiment may adjust, at 304, a window size of the application. In an embodiment, the window size may be adjusted to a larger size, a smaller size, to a predetermined display mode (e.g., full screen, half screen, quad screen, restore down, etc.), or the like. In an embodiment, the determination on how to adjust the window size may be based upon a user-defined window size setting, a display parameter of the target display, or a combination of the two factors.

In an example situation where an embodiment adjusts the size of an application solely based on a user-defined window size setting, an embodiment may identify that a user prefers to watch media playing applications in full screen mode using any of the previously discussed techniques. An embodiment may use that information to dynamically adjust the size of all media playing applications to full screen mode when they are transferred to another display, regardless of display size. For example, when a user transfers the application from a laptop to a television set, the system may display the application in full screen mode regardless of the display size. In an example situation where an embodiment adjusts the size of an application solely based on a display parameter of a display screen, an embodiment may identify that a user prefers to read electronic documents in e-reading applications in full screen mode on a small display screen (e.g., a smart phone display screen, tablet, hand held device, etc.) but prefers to view the same electronic documents in half screen mode on a larger display screen (e.g., a 15″ computer monitor, television set, large tablet, etc.). Thus, when the user transfers the e-reading application, displayed in full-screen mode on the smaller display, to the larger display, the system may display the application in half-screen mode.

In an example situation where an embodiment adjusts the size of an application based upon a combination of an identified user-defined window size setting and a display parameter, an embodiment may identify that a user's most recent window size setting for a media playing application opened on a smaller screen (e.g., smart phone display screen, tablet display screen, etc.) was full screen mode. However, when the same media playing application was opened on a larger screen (e.g., a computer monitor, television monitor, etc.), the user adjusted the window size of the application to half screen mode. Accordingly, in this example, an embodiment may use a combination of the most recent window setting identified, as well as the identified display sizes of the display screens, to dynamically adjust the window size of the media playing application to full screen when an embodiment identifies that the application is playing on a smaller screen and to half screen mode when an embodiment identifies that the application is playing on a larger screen.

In an embodiment, the window sizes of other applications presently displayed on a target display screen may be dynamically adjusted subsequent to displaying a transferred application on the target display screen. For example, when a word processing application is moved to a computer monitor currently displaying a media playing application in full screen mode, an embodiment may display the word processing application in half screen mode on the monitor and may adjust (e.g., either simultaneously or subsequently) the currently playing media application to half screen mode. Similar to determining the size the application should be displayed at, the determination of whether other applications are resized may be based upon the display screen parameters and/or user-defined settings.

At 305, responsive to not identifying a rule set corresponding to at least one of a display parameter and a user-defined window size setting, an embodiment may display the application in a predetermined display mode. At 306, an embodiment may query the user (e.g., using a notification box, providing a prompt to the user, another visual representation, etc.) to establish sizing rules for the displayed application. For example, subsequent to transferring an application between screens, an embodiment may provide the user with a visual message (e.g., a notification box, prompt, etc.) requesting whether the user wants to establish sizing rules for the transferred applications. The sizing rules may be based upon a user-defined window size setting, a display parameter of the display, or a combination of the two. Thereafter, an embodiment may refer to the predefined sizing rules when displaying the application.

The various embodiments described herein thus represent a technical improvement to conventional application window sizing techniques. Using the techniques described herein, a window size for an application may be dynamically adjusted to a preferred window size for a user depending upon at least one of a user-defined window size setting and a display parameter of a display. Such techniques eliminate the need for a user to manually adjust the window size of an application each time the application is initiated or is transferred between display screens.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to display at least one application on a display screen connected to the information handling device;
accessing, using a processor, a rule set comprising rules for adjusting a window size for the at least one application based upon a display parameter of the display screen and a user-defined window size setting; and
adjusting, based upon the rule set, the window size of the at least one application.

2. The method of claim 1, wherein the display parameter comprises at least one of display screen size or display screen resolution.

3. The method of claim 1, wherein the indication comprises at least one of an initiation event or a repositioning event.

4. The method of claim 3, wherein the indication comprises the repositioning event, wherein repositioning event comprises transferring the application to the display screen from another display screen, wherein the display parameter of the display screen is different than the display parameter of the another display screen.

5. The method of claim 1, wherein the user-defined window size setting defines a window size for the at least one application and is selected from the group consisting of a recent window size, a frequent window size, and a crowdsourced window size.

6. The method of claim 5, wherein the user-defined window size setting comprises the recent window size and wherein the recent window size comprises identifying a last user input associated with adjusting the window size of the at least one application.

7. The method of claim 5, wherein the user-defined window size setting comprises the frequent window size and wherein the frequent window size comprises analyzing prior user inputs associated with adjusting the window size of the at least one application and identifying a most common window size of the at least one application from the prior user inputs.

8. The method of claim 5, wherein the user-defined window size setting comprises the crowdsourced window size, wherein the crowdsourced window size comprises:
accessing, using a processor, a database comprising stored input data from a plurality of users, wherein the stored input data comprises adjustment data for adjusting the window size of the at least one application; and
identifying, from the stored input data, a most common window size for the at least one application.

9. The method of claim 1, further comprising adjusting a window size of another application currently displayed on the display screen based on the adjusting.

10. The method of claim 1, wherein the adjusting is based upon at least in part a user input.

11. An information handling device, comprising:
a processor;
a memory device that stores instructions executable by the processor to:
receive an indication to display at least one application on a display screen connected to the information handling device;
access a rule set comprising rules for adjusting a window size for the at least one application based upon on a display parameter of the display screen and a user-defined window size setting; and
adjust, based on the rule set, the window size of the at least one application.

12. The information handling device of claim 11, wherein the display parameter comprises at least one of display screen size or display screen resolution.

13. The information handling device of claim 11, wherein the indication comprises at least one of an initiation event or a repositioning event.

14. The information handling device of claim 13, wherein the indication comprises the repositioning event, wherein the repositioning event comprises transferring the application to the display screen from another display screen, wherein the display parameter of the display screen is different than the display parameter of the another display screen.

15. The information handling device claim 11, wherein the user-defined window size setting defines a window size for the at least one application and is selected from the group consisting of a recent window size, a frequent window size, and a crowdsourced window size.

16. The information handling device of claim 15, wherein the user-defined window size setting comprises the recent window size and wherein the recent window size comprises identifying a last user input associated with adjusting the window size of the at least one application.

17. The information handling device of claim 15, wherein the user-defined window size setting comprises the frequent window size and wherein the frequent window size comprises analyzing prior user inputs associated with adjusting the window size of the at least one application and identifying a most common window size of the at least one application from the prior user inputs.

18. The information handling device of claim 15, wherein the user-defined window size setting comprises the crowdsourced window size, wherein the crowdsourced window size comprises:
accessing, using a processor, a database comprising stored input data from a plurality of users, wherein the stored input data comprises adjustment data for adjusting the window size of the at least one application; and
identifying, from the stored input data, a most common window size for the at least one application.

19. The information handling device of claim 11, wherein the instructions executable by the processor further comprise instructions executable by the processor to adjust a window size of another application currently displayed on the display screen based on the instructions executable by the processor to adjust.

20. A product, comprising:
a storage device that stores code, the code being executable by a processor and comprising:
code that receives an indication to display at least one application on a display screen connected to an information handling device;
code that accesses a rule set comprising rules for adjusting a window size for the at least one application based upon a display parameter of the display screen and a user-defined window size setting; and
code that adjusts, based on the rule set, the window size of the at least one application.
